(19) United States
(12) Patent Application Publication
(10) Pub. No.: US 2026/0050435 A1
(43) Pub. Date: Feb. 19, 2026

(54) AUTOMATED CONFIGURATION OF COMPUTING CLUSTERS

(71) Applicant: Massachusetts Mutual Life Insurance Company, Springfield, MA (US)

(72) Inventors: Harshavardhan Nerella, Austin, TX (US); Gheorghe Digori, Bucharest (RO); Ethan Jampel, Cambridge, MA (US); Don Isururaja Batugahage, Charlotte, NC (US)

(73) Assignee: Massachusetts Mutual Life Insurance Company, Springfield, MA (US)

(21) Appl. No.: 18/806,010

(22) Filed: Aug. 15, 2024

(51) Int. Cl. G06F 8/71; G06F 9/50

(52) U.S. Cl. CPC G06F 8/71; G06F 9/5027

(57) ABSTRACT

Presented herein are systems and methods of automatically generating files for defining computing clusters. A server may maintain a code base including a plurality of files to define an infrastructure of a computing cluster. The server may identify a first file including a first plurality of parameters for configuring the computing cluster. The server may generate, using the first file and the code base, a second plurality of parameters to define a corresponding plurality of resources for creation of the computing cluster. The server may create a second file to define the infrastructure of the computing cluster, using the first plurality of parameters and the second plurality of parameters. The server may establish the infrastructure of the computing cluster in accordance with the second file.

### TECHNICAL FIELD

This application relates generally to automatically generating terraform files defining computing cluster pre-requisite infrastructure and configuration files defining resources for computing clusters.

### BACKGROUND

A computing cluster may have a multitude of nodes to host resources and provide various services, individually or in orchestration with one another. Each node may be executed on a physical or virtual machine and may run and execute process to provide the services. To facilitate the operations, the computing cluster may be supported by a large set of infrastructure and resources. These infrastructure and resources underlying the computing cluster may be updated from time-to-time. Carrying out such updates may be, however, complex and challenging due to a plethora of factors, such as the number of nodes, services, and resources involved in the computing cluster. Furthermore, updating a portion of the computing cluster may impact the operations in another portion of the computing cluster.

### SUMMARY

In a network environment, a computing cluster may include a set of nodes configured in accordance with a cluster architecture for orchestrating the nodes of the cluster. The control plane corresponding to one of the nodes may manage and handle the infrastructure and resources for the overall set of nodes in the computing cluster. Each of the remaining nodes may manage local resources and execute processes to provide various services. The computing cluster may also have a configuration state defining specification for the nodes within the cluster. The configuration state may identify, for example, which region, networking and virtual machine for the nodes in the cluster among many other. The configuration state may be defined by a cluster specification file. The cluster specification file may specify which role to leverage and resources among the set of nodes in the computing cluster. By modifying the cluster specification file, the configuration state for the computing cluster may be updated.

There may be many a number of technical challenges in creating and updating the computing cluster. First, the creation of computing clusters may consume a significant amount of time (e.g., on the order of weeks) and effort on the part of the system administrator managing the computing cluster. The prolonged setup time may be due to inconsistency and shear complexity of the processes for creating and updating computing clusters, especially with manual interventions in editing the configuration file and troubleshooting after rolling out with multiple updates. Second, the lifecycle management processes from creation, through upgrading, to deletion may lead computing clusters to becoming more vulnerable to security lapses and maintained at out of support for older versions. Third, the creation, upgrades, and maintenance of computing cluster may entail a high-level of expertise, especially in the composing and rewriting of cluster specification files. This may be especially problematic when handling a multitude (e.g., on the order of tens or hundreds) of computing clusters for an enterprise system or network. All of these difficulties may lead to lack of scalability, degradation in efficiencies, and reduction in security in computing cluster management.

To address these and other technical challenges, a cluster management system may automatically generate configuration files to manage and facilitate creation, updating, and management of the computing cluster. The cluster management system may maintain a code base (sometimes referred herein as a main branch) including a set of configuration files defining a multitude of parameters for the configuring the computing cluster. In managing the code base, the cluster management system may provide a dashboard interface with which the system administrator may input values for parameters defining the pre-requisite infrastructure and resources of the computing cluster for a terraform file (e.g., a “main.tf” file). The parameters may define various aspects of pre-requisite infrastructure and resources for the computing cluster, such as cloud service providers, user groups, application team metadata, tags, terraform provider versions, and cluster identifiers, among others. The cluster management system may identify the terraform file, as selected by the user via the dashboard interface.

With the identification, the cluster management system may merge the terraform file with the code base by executing the files in a workspace. From execution in the workspace, the cluster management system may generate or derive a new, fuller set of parameters for the computing cluster. The new set of parameters may define the infrastructure and resources for the computing cluster, including an identity and access management (IAM) role identification, a key management service (KMS) keys, projects, groups, and access management policies, among others. The cluster management system may also interface with the cloud service provider to retrieve additional parameters such as subnets, DNS and many others. Using the parameters, the cluster management system may construct a cluster specification file (e.g., as an extensible markup language (XML), YAML, or JavaScript Object Notation (JSON) file). The cluster specification file may include the full definition of the infrastructure and resources for the computing cluster. Using the cluster specification file, the cluster management system may create the computing cluster or update the configuration state of the computing cluster.

In this manner, the cluster management system may create and roll out upgrades on the computing cluster, with automatically generated configuration files with minimal input from the system administrator. Once the system administrator identifies cluster specification file (e.g., in YAML format) to be used, the cluster management system may automatically handle the remainder of the upgrading process for the computing cluster in a seamless fashion, aggregating parameters from various sources to construct the cluster configuration file. This process may be completed in the matter of minutes, relative to the order of days or weeks with manual intervention approaches. The cluster management system may facilitate creation and life cycle management of computing clusters and may reduce the manual intervention in creating and defining computing clusters, thereby lessening the burden and efforts on the part of the system administrator. The cluster management system may ensure consistent creation of the computing clusters across multiple environments and regions, with the code base as a repository for files to define the infrastructure and resources of computing clusters. The cluster management system may thus improve the operational health and security of the overall computing cluster, thereby increasing efficiency in maintaining computing clusters.

Aspects of the present disclosure are directed to systems and methods of automatically generating files for defining computing clusters. One or more processors may maintain a code base including a plurality of files to define an infrastructure of a computing cluster including a plurality of nodes. The one or more processors may identify a first file including a first plurality of parameters for configuring the computing. The one or more processors may generate, using the first file with at least one of the plurality of files of the code base, a second plurality of parameters to define a corresponding plurality of resources for creation of the computing cluster. The one or more processors may create a second file to define the infrastructure of the computing cluster, using the second plurality of parameters in accordance with a template. The one or more processors may establish the infrastructure of the computing cluster in accordance with the second file.

In one embodiment, the one or more processors may provide a user interface comprising a user interface element to input one or more of the first plurality of parameters for configuring the computing cluster pre-requisite infrastructure. The one or more processors may receive, via the user interface, the first file generated using the first plurality of parameters inputted via the user interface.

In another embodiment, the one or more processors may receive, via the user interface, a selection of one of acceptance or rejection of the second plurality of parameters. The one or more processors may create, responsive to the selection of the acceptance of the second plurality of parameters, the second file in accordance with the template, the template identifying a plurality of fields and a corresponding plurality of values for the plurality of resources for the creation of the computing cluster.

In yet another embodiment, the one or more processors may access a cloud service provider and resource orchestrator supporting the computing cluster, to retrieve a third plurality of parameters defining a second corresponding plurality of resources for the infrastructure of the computing cluster, the third plurality of parameters identified by the template. The one or more processors may create the second file using the third plurality of parameters from the cloud service provider and resource orchestrator.

In yet another embodiment, the one or more processors may receive, via the user interface, a selection of one of acceptance or rejection of the second file. The one or more processors may create the infrastructure of the computing cluster in accordance with the second file, responsive to the selection of the acceptance.

In yet another embodiment, the one or more processors may execute, in a workspace associated with the code base, the first file combined with at least one of the plurality of files. The one or more processors may generate the second plurality of parameters based on execution of the first file combined with at least one of the plurality of files in the workspace.

In yet another embodiment, the one or more processors may receive, via the user interface, an indication to use the second file for updating a plurality of computing clusters. The one or more processors may update each of the plurality of computing clusters in accordance with the second file. In yet another embodiment, the one or more processors may update a control plane of the computing cluster using the second file, the control plane configured to manage resources and a configuration of the computing cluster.

In yet another embodiment, the first file may include a terraform file to define the creation of the infrastructure of the computing cluster, and the first plurality of parameters may include at least one of: (i) an account identifier, (ii) a workspace identifier, or (iii) a version identifier. In yet another embodiment, the second file may include a cluster specification file to define resources of the computing cluster, and the second plurality of parameters may include at least one of: (i) an identity and access management (IAM) role identification, (ii) a key management service (KMS) key, or (iii) an access management for users. In yet another embodiment, the computing cluster may include at least one primary node managing the plurality of nodes, at least one of the plurality of nodes associated with a container to provide a service.

It is to be understood that both the foregoing general description and the following detailed description are exemplary and explanatory and are intended to provide further explanation of the invention as claimed.

### BRIEF DESCRIPTION OF THE DRAWINGS

The accompanying drawings constitute a part of this specification, illustrate an embodiment of the invention, and, together with the specification, explain the invention.

FIG. 1 illustrates a block diagram of a computer environment for automatically generating files for computing clusters, in accordance with an embodiment.

FIG. 2 illustrates a block diagram of a system for merging terraform files with code base files to generate parameters to define the pre-requisite infrastructure for computing clusters, in accordance with an embodiment.

FIG. 3 illustrates a block diagram of a system for creating cluster specification files to update create computing clusters, in accordance with an embodiment.

FIGS. 4A-C illustrate a block diagram of a process of automatically generating files to define resources for computing clusters, in accordance with an embodiment.

FIG. 5A illustrates a screenshot of a user interface to update and create terraform files, in accordance with an embodiment.

FIG. 5B illustrates a screenshot of a user interface to indicate automation for creation of workspace, in accordance with an embodiment.

FIG. 5C illustrates a screenshot of a user interface to indicate an automation for updating the cluster specification file to upgrade the cluster, in accordance with an embodiment.

FIG. 5D illustrates a screenshot of a user interface to indicate status of updating of computing clusters using cluster specification files, in accordance with an embodiment.

FIG. 6 illustrates a flow diagram of a method of automatically generating files for defining computing clusters, in accordance with an embodiment.

### DETAILED DESCRIPTION

Reference will now be made to the exemplary embodiments illustrated in the drawings, and specific language will be used here to describe the same. It will nevertheless be understood that no limitation of the scope of the invention is thereby intended. Alterations and further modifications of the inventive features illustrated here, and additional applications of the principles of the inventions as illustrated here, which would occur to a person skilled in the relevant art and having possession of this disclosure, are to be considered within the scope of the invention.

Presented herein are systems and methods for automatically generating configuration files. A cluster management system may maintain a code base (sometimes referred herein as a main branch) including a set of configuration files defining a multitude of parameters for configuring the computing cluster. The cluster management system may identify a terraform file (e.g., a “main.tf” file) defining the infrastructure and resources for the computing cluster. With the identification, the cluster management system may merge the terraform file with the code base by executing the files in a workspace and derive a new set of parameters for the computing cluster. Using the parameters, the cluster management system may construct a cluster specification file including the newer, full definition of the infrastructure and resources for the computing cluster. Using the cluster specification file, the cluster management system may create the computing cluster or update the configuration of the computing cluster.

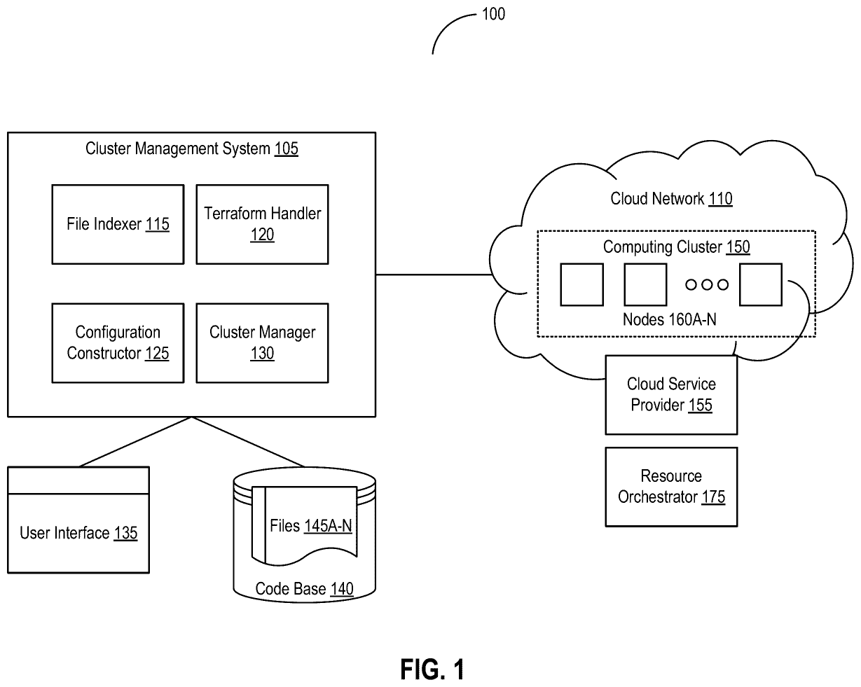

FIG. 1 illustrates a block diagram of a system or computer environment 100 for automatically generating files for defining computing clusters pre-requisite infrastructure. In overview, the computing environment 100 may include at least one cluster management system 105 and at least one cloud network 110, communicatively coupled with each other. The cluster management system 105 may include at least one file indexer 115, at least one terraform handler 120, at least one configuration constructor 125, and at least one cluster manager 130, at least one user interface 135, and at least one code base 140, among others. The code base 140 may store, maintain, or otherwise include a set of files 145A-N (hereinafter generally referred to as files 145). The cluster network 110 may include at least one computing cluster 150 and at least one cloud service provider 155, among others. The computing cluster 150 may include a set of nodes 160A-N (hereinafter generally referred to as nodes 160). In some embodiments, the environment 100 or the cloud network 110 may include at least one resource orchestrator 175.

Embodiments may comprise additional or alternative components or omit certain components from those of FIG. 1 and still fall within the scope of this disclosure. For example, the cluster management system 105, the cloud network 110, and the cloud service provider 155 may be part of the same device. Various hardware and software components of one or more public or private networks may interconnect the various components of the computing environment 100. Non-limiting examples of such networks may include Local Area Network (LAN), Wireless Local Arca Network (WLAN), Metropolitan Area Network (MAN), Wide Area Network (WAN), and the Internet. The communication over the network may be performed in accordance with various communication protocols, such as Transmission Control Protocol and Internet Protocol (TCP/IP), User Datagram Protocol (UDP), and IEEE communication protocols.

In further detail, the cluster management system 105 may be any computing device including one or more processors coupled with memory and software and capable of performing the various processes and tasks described herein. The cluster management system 105 may be associated with an entity (e.g., a system administrator) administering one or more computing clusters 150 on one or more cloud networks 110 to provide services for at least one enterprise network. The cluster management system 105 may be in communication with the code base 140, the cloud network 110, resource orchestrator 175, and the cloud service provider 155, among others. Although shown as a single cluster management system 105, the cluster management system 105 may include any number of computing devices. In some embodiments, the cluster management system 105 may be separate from the cloud service provider 155 (e.g., as depicted). In some embodiments, the cluster management system 105 may be part of the cloud service provider 155, or vice-versa.

The cluster management system 105 may include several subsystems to perform the operations described herein. On the cluster management system 105, the file indexer 115 may maintain the set of files 145 for the computing cluster 150 on the code base 140. The terraform handler 120 may retrieve terraform files for defining resources for the computing cluster 150. The configuration constructor 125 may create cluster specification files from inputs from user interface and using the resources created by executing terraform files and the files 145 on the code base 140. The cluster manager 130 may create, update, and maintain the computing cluster 150 in accordance with cluster specification files. The user interface 135 may be a graphical user interface (GUI) with one or more user interface elements to exchange inputs and outputs with the cluster management system 105. The code base 140 may store and maintain the set of files 145 to define infrastructure and resources for the computing cluster 150.

The cloud network 110 may include or correspond to a defined network in which the set of nodes 160 of the computing cluster 150 and the cloud service provider 155 communicate with one another. The cloud network 110 may include a virtualized network infrastructure provided and managed by the cloud service provider 155 to support the communications among the set of nodes 160 in the computing cluster 110. The infrastructure may include, for example, a virtual cloud (e.g., a virtual private network or cloud), subnets, security groups, load balancers, routing, and various components among others.

The computing cluster 150 may include or correspond to the set of nodes 160 in the cloud network 110. In the computing cluster 150, the set of nodes 160 may be interconnected with one another, orchestrating to perform various process and provide resources. The computing cluster 150 may be associated with the same entity as the cluster management system 105 to provide services for at least one enterprise network. In some embodiments, at least one of the nodes 160 in the computing cluster 150 may be a control plane (or a primary or principal node) to manage the definition and allocation of resources for the remaining nodes. Each of the remaining nodes 160 may perform process using the allocated resources to provide the services. In some embodiments, at least one of the nodes 160 in the computing cluster 150 may be associated with at least one container to provide the services (e.g., for a computing device accessing the computing cluster 150). The container may process workloads and execute process on the node 160. The set of nodes 160 of the computing cluster 150 may be in accordance with various container or orchestration systems, such as Kubernetes™, Deeket-Docker Swarm™, Apache Mesos™, OpenShift™, Nomad™, Rancher™, Elastic Container Service™, or Azure Container Instances™, among others.

The cloud service provider 155 may be any computing device including one or more processors coupled with memory and software and capable of performing the various processes and tasks described herein. The cloud service provider 155 may facilitate or manage the computing cluster 150 including the set of nodes 160. The cloud service provider 155 may include a cloud-based service, e.g. Software as a Service (SaaS), Platform as a Service (PaaS), and Infrastructure as a Service (IaaS). IaaS may refer to a user renting the use of infrastructure resources that are needed during a specified time period. IaaS providers may offer storage, networking, servers or virtualization resources from large pools, allowing the users to quickly scale up by accessing more resources as needed. PaaS providers may offer functionality provided by IaaS, including, e.g., storage, networking, servers or virtualization, as well as additional resources such as, e.g., the operating system, middleware, or runtime resources. SaaS providers may offer the resources that PaaS provides, including storage, networking, servers, virtualization, operating system, middleware, or runtime resources. In some embodiments, SaaS providers may offer additional resources including, e.g., data and application resources.

The resource orchestrator 175 may be any computing device including one or more processors coupled with memory and software and capable of performing the various processes and tasks described herein. The resource orchestrator 175 may facilitate deployment, management, and configuration of the computing cluster 150. For instance, the resource orchestrator 175 may be a Kubernetes orchestration platform to handle containerized applications running on the set of nodes 160 in the computing cluster 150. The resource orchestrator 175 may provide to the interface to the users to view, create, or update the various containerized applications running on the set of nodes 160 in the computing cluster 150. In some embodiments, the resource orchestrator 175 may be a part of the cloud service provider 155. In some embodiments, the resource orchestrator 175 may be separate from the cloud service provider 155 (as depicted).

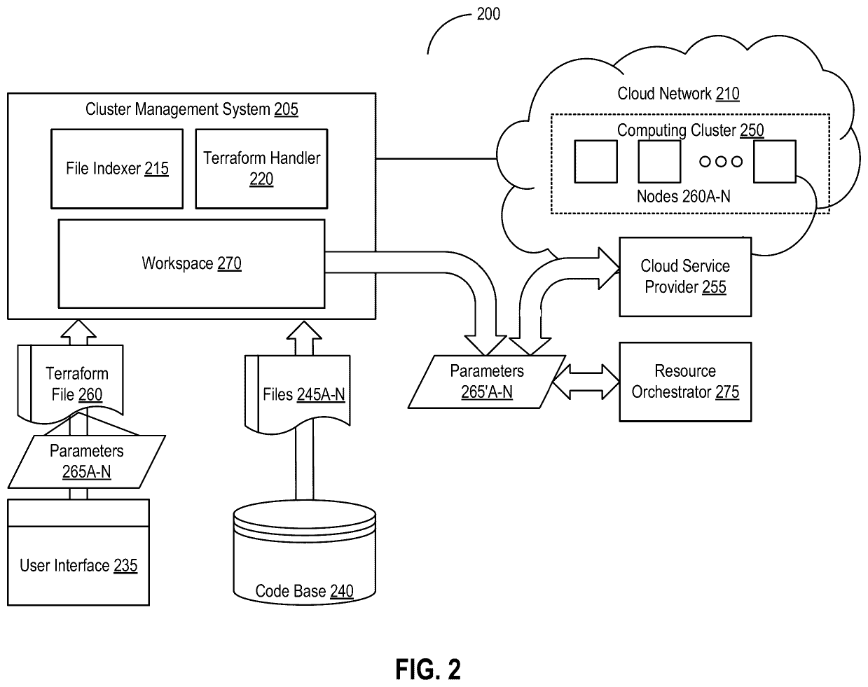

FIG. 2 illustrates a block diagram of a system 200 for merging terraform files with code base files to generate parameters to define computing clusters. The system 200 may include at least one cluster management system 205 and at least one cloud network 210, among others. The cluster management system 205 may include at least one file indexer 215, at least one terraform handler 220, at least one user interface 235, at least one code base 240, and at least one workspace 270, among others. The cloud network 210 may include at least one computing cluster 250 and at least one cloud computing service 255, among others. The system 200 may also include at least one resource orchestrator 275. The computing cluster 250 may include a set of nodes 260A-N (hereinafter generally referred to as nodes 260). Embodiments may comprise additional or alternative components or omit certain components from those of FIG. 2 and still fall within the scope of this disclosure. Various hardware and software components of one or more public or private networks may interconnect the various components of the system 200. Each component in system 200 (such as the cluster management system 205, the cloud network 210, the computing cluster 250, and the cloud service provider 255) may be any computing device comprising one or more processors coupled with memory and software, and capable of performing the various processes and tasks described herein.

The file indexer 215 on the cluster management system 205 may maintain the code base 240 including a set of files 245A-N (hereinafter generally referred to as the set of files 245). The code base 240 may serve or function as a centralized repository for the set of files 245 used to define or configure the infrastructure and resources of the computing cluster 250. For example, the code base 240 may store a history of commits of the code from the files 245, modifications to the code, and versions of code and branches, among others. The code base 240 may identify or include one or more branches associated with the computing cluster 250. At least one of the branches may be a main branch that corresponds to the current configuration of the computing cluster 250 on the cloud network 210. The set of files 245 may correspond to the main branch on the code base 240. In some embodiments, the set of files 245 may define the infrastructure and resources for an already existing computing cluster 250 on the cloud network 210. In some embodiments, the set of files 245 may define the infrastructure and resources for a to-be-created computing cluster 250 on the cloud network 210.

The set of files 245 may define the resources and infrastructure of the computing cluster 250 in a specified configuration (sometimes referred herein as a state). The configuration may correspond to a current definition of the infrastructure and resources for the computing cluster 250. The configuration may identify or include, for example, an identification of the set of nodes 260 (e.g., cluster name, region, and number of nodes), networking configurations (e.g., virtual private cloud, subnets, version identifier, cloud service provider region, and identification of the cloud service provider 255), specification for the nodes 260 (e.g., virtual machine image, desired node count, maximum node count, minimum node count, and authentication information), storage for each node 260 (e.g., storage volume, storage classification, and size and access mode), security and access control (e.g., access control, security settings, and network policies), resource quotas (e.g., constraints on computing resources), and continuous integration and continuous deployment (CI/CD) settings, among others. The set of files 245 may include, for example, a configuration specification file to define the infrastructure or resources of the computing cluster 250 (e.g., in the XML, JSON, or YAML format), documentation file, environment configuration file, and other script files, among others.

In conjunction, the terraform handler 220 on the cluster management system 205 may retrieve, receive, or otherwise identify at least one terraform file 260 (sometimes herein referred to as a terraform configuration file or a cluster pre-requisite file). The terraform file 260 may identify, specify, or otherwise identify an update, configuration, or creation of the pre-requisite infrastructure for computing cluster 250. The terraform file 260 may include, specify, or identify a set of parameters 265A-N (hereinafter generally referred to as the set of parameters 265). In some embodiments, the set of parameters 265 of the terraform file 260 may include an account identifier (e.g., corresponding to the system administrator), tags (e.g., metadata related to the developers such a cost center or email identifier), credentials (credentials that allow programmatic access to cloud service provider 255), and cloud provider region, among others.

The terraform handler (a workflow) 220 may present or provide the user interface 235 to accept, receive, or otherwise input values for one or more of the set of parameters 265 for the configuration of the pre-requisite infrastructure for computing cluster 250. The user interface 235 may include or may be a graphical user interface (e.g., for a web application) including one or more user interface elements for the system administrator to input the values for the parameters 265. Using the inputs via the user interface 235, the terraform handler 220 may write, create, or otherwise generate the terraform file 260 to include the set of parameters 265. In some embodiments, the terraform handler 220 may provide the user interface 235 to input an identification of the terraform file 260. For instance, the user interface 235 may be used by the system administrator to enter a file name and path for the terraform file 260 to be used to define the new, updated configuration for the pre-requisite infrastructure for computing cluster 250.

In some embodiments, to generate the set of parameters 265′, the terraform handler 220 may execute the terraform file 260 in the workspace 270. The workspace 270 may include or correspond to an isolated environment to execute the terraform file 260 to create the parameters 265′ or pre-requisite infrastructure for the computing cluster 250. The execution of the terraform file 260 in the workspace 270 may result in the generation in the set of parameters 265′. In some embodiments, the execution of the terraform file 260 in the workspace 270 may generate at least a portion of the set of parameters 265′ in conjunction with the cloud service provider 255. The portion of parameters 265′ may identify or include, for example, an identity and access management (IAM) role identification (e.g., definition of actions permissible for a given identity or service) and a key management service (KMS) key (e.g., cryptographic key used to encrypt), among others. In some embodiments, the execution of the terraform file 260 in the workspace 270 may generate at least a portion of the set of parameters 265′ in conjunction with the resource orchestrator 275. The portion of parameters 265′ may identify or include, for example, project and group definitions (e.g., in accordance with Rafay groups), and a group association for users of the computing cluster 250, among others. Upon completion of the execution, the terraform handler 220 may generate the set of parameters 265′ from the output of the workspace 270. With the creation of the terraform file 260, the terraform handler 220 (or the system administrator) may add, join, or otherwise merge the terraform file 260 with the main branch corresponding to the set of files 245 on the code base 240.

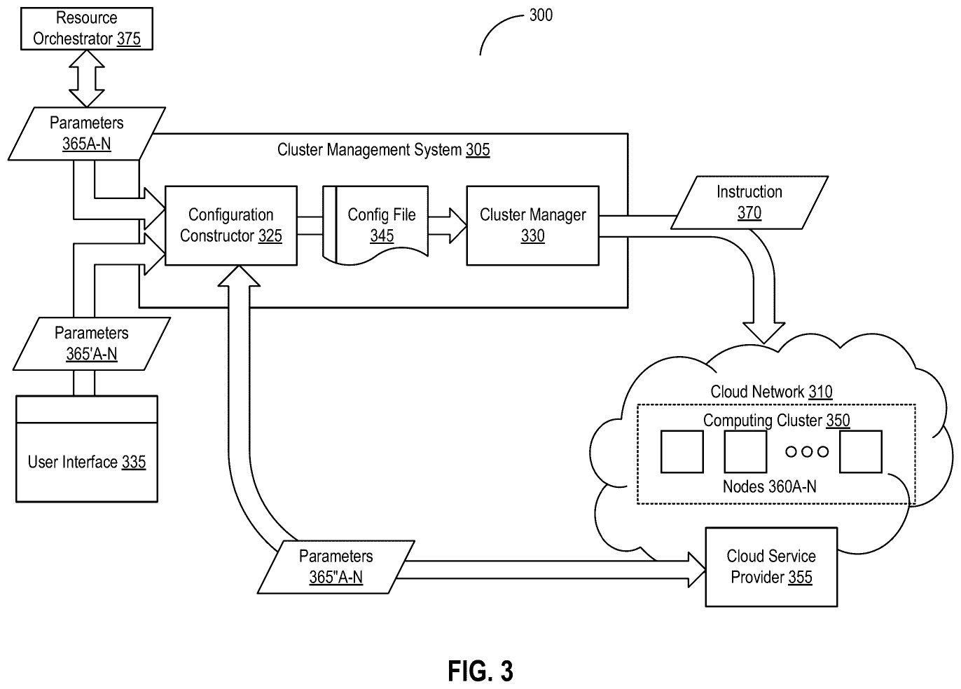

FIG. 3 illustrates a block diagram of a system 300 for creating cluster specification files to create and update computing clusters. The system 300 may include at least one cluster management system 305 and at least one cloud network 310, among others. The cluster management system 305 may include at least one configuration constructor 325, at least one cluster manager 330, and at least one user interface 335, among others. The cloud network 310 may include at least one computing cluster 350 and at least one cloud computing service 355, among others. The computing cluster 350 may include a set of nodes 360A-N (hereinafter generally referred to as nodes 360). The system 300 may also include at least one resource orchestrator 375. Embodiments may comprise additional or alternative components or omit certain components from those of FIG. 3 and still fall within the scope of this disclosure. Various hardware and software components of one or more public or private networks may interconnect the various components of the system 300. Each component in system 300 (such as the cluster management system 305, the cloud network 310, the computing cluster 350, and the cloud service provider 355) may be any computing device comprising one or more processors coupled with memory and software, and capable of performing the various processes and tasks described herein.

The configuration constructor 325 on the cluster management system 305 may determine, generate, or otherwise create at least one configuration file 345 (sometimes herein referred to as a cluster specification file) using a set of parameters 365A-N and 365″A-N (hereinafter generally referred to as parameters 365 and 365″) in accordance with a template. The set of parameters 365 and 365″ may have been generated using a terraform file and one or more of the files on a code base. The set of parameters 365 and 365″ may define the creation of the infrastructure and resources of the computing cluster 350. The template used to create the configuration file 345 may specify or define a set of fields and a set of values for the infrastructure and resources of the computing cluster 350. The configuration file 345 may be, for example, in a YAML, JSON, or XML format, created using the template.

The configuration file 345 may include or identify a set of parameters 365′A-N (hereinafter generally referred to as set of parameters 365′). The set of parameters 365′ may include a full definition of the infrastructure and resources for the computing cluster 350, such as the identification of the set of nodes 360, cloud provider, version (e.g., Kubernetes version), networking configurations, specification for the nodes 260, storage for each node 260, security and access control, resource quotas, and CI/CD settings, among others. In addition, the set of parameters 365 and 365″ may include or identify additional aspects of the infrastructure and resources of the computing cluster 350, such as an identity and access management (IAM) role identification (e.g., definition of actions permissible for a given identity or service), a key management service (KMS) key (e.g., cryptographic key used to encrypt and decrypt data exchanged with the nodes 360 of the computing cluster 350), an access management for users (e.g., security and control policies for users), project and group definitions (e.g., in accordance with Rafay groups), a group association for users of the computing cluster 350, among others. With the creation of the configuration file 345, the configuration constructor 325 may store and maintain the configuration file 345 on the code base (e.g., as part of the main branch).

In some embodiments, the configuration constructor 325 may provide the user interface 335 to control or manage creation of the configuration file 345 for defining the creation or updating of the computing cluster 350. In some embodiments, the configuration constructor 325 may provide the user interface 335 to accept, retrieve, or otherwise receive input of one or more parameters 365′ to define the creation or updating of the computing cluster 350. The parameters 365′ received via the user interface 335 may include, for example, a desired number of nodes, a maximum number of nodes, a minimum number of nodes, a version identifier (e.g., a Kubernetes version), a virtual machine image identifier (e.g., an AMI identifier), a user identifier, an environment, or tags, among others. With the receipt, the configuration constructor 325 may add or include the parameters 365′ in the configuration file 345. In some embodiments, the configuration constructor 325 may add or include the parameters 365 generated from the execution and merger of the terraform file and the parameters 365′ received via the user interface 335 into the configuration file 345.

In some embodiments, the configuration constructor 325 may provide the user interface 335 to provide selection (e.g., by the system administrator) of acceptance or rejection of the set of parameters 365′ for the computing cluster 350. When the selection corresponds to acceptance of the set of parameters 365′, the configuration constructor 325 may proceed with generating the configuration file 345. When the selection corresponds to rejection of the set of parameters 365′, the configuration constructor 325 may refrain from generating the configuration file 345. In some embodiments, the configuration constructor 325 may retrieve, identify, or otherwise receive one or more modifications (e.g., change in virtual machine image or Kubernetes version) to the set of parameters 365′ via the user interface 335. The configuration constructor 325 may generate the configuration file 345 to include one or more modifications.

In some embodiments, the configuration constructor 325 may provide the user interface 335 to provide selection (e.g., by the system administrator) of acceptance or rejection of the set of parameters 365′ of the configuration file 345 for the computing cluster 350. The provision may be in response to the generation of the configuration file 345. When the selection corresponds to acceptance of the set of parameters 365′, the configuration constructor 325 may proceed with using the configuration file 345 to create or update the computing cluster 350. When the selection corresponds to rejection of the set of parameters 365′, the configuration constructor 325 may refrain from proceeding with the configuration file 345 to update the computing cluster 350. In some embodiments, the configuration constructor 325 may retrieve, identify, or otherwise receive one or more modifications (e.g., virtual machine image or Kubernetes version) to the set of parameters 365′ in the configuration file 345 via the user interface 335. The configuration constructor 325 may alter, change, or otherwise modify the configuration file 345 to include one or more modifications.

Upon merger and execution of the terraform file, the configuration constructor 325 may interface with the cloud service provider 355 and the resource orchestrator 375 to retrieve resources, such as IAM, KMS, project, groups, group association, cloud credentials (credentials that allow programmatic access to cloud service provider 355), cloud provider region, and service role (e.g., serviceRoleARN (IAM Role) and instanceRoleARN (IAM Role)), among others. As the resources are created by the cloud service provider 355 and the resource orchestrator 375, the cloud service provider 355 and the resource orchestrator 375 may provide the set of parameters 365″ and 365 to the configuration constructor 325 for the generation of the configuration file 345. With the retrieval of the set of parameters 365″ and 365, the configuration constructor 325 may include the set of parameters 365″ and 365 as part of the set of parameters 365′ in the configuration file 345. In some embodiments, the configuration constructor 325 may use the set of parameters 365″ and 365 as defined by the template for creating the configuration file 345.

The cluster manager 330 on the cluster management system 305 may establish the infrastructure and resources of the computing cluster 350, in accordance with the configuration file 345. In some embodiments, the cluster manager 330 may interface or communicate with the cloud service provider 355 and resource orchestrator 375 to establish the infrastructure and resources of the computing cluster 350, in conjunction with the creation of the configuration file 345. To establish, the cluster manager 330 may apply or provide at least one instruction 370 to the computing cluster 350 on the cloud network 310 in accordance with the set of parameters 365, 365′ and 365″ of the configuration file 345. The cluster manager 330 may map, transform, or otherwise convert the set of parameters 365, 365′ and 365″ defined in the configuration file 345 to a set of configurations to include in the instruction 370 to apply to the computing cluster 350. In providing the instruction 370, the cluster manager 330 may reconfigure the individual nodes 360 within the computing cluster 350. In some embodiments, the cluster manager 330 may update at least one node 360 corresponding to the control plane (or primary or principal node). The node 360 corresponding to the control plane may in turn configure the infrastructure and resources for at least a portion of the remainder of the nodes 360 in the computing cluster 350.

In some embodiments, the cluster manager 330 may instantiate or create the computing cluster 350 on the cloud network 310 in accordance with the set of parameters 365′ of the configuration file 345. To instantiate, the cluster manager 330 may apply or provide at least one instruction 370 to the computing cluster 350 on the cloud network 310 in accordance with the set of parameters 365′ of the configuration file 345. The cluster manager 330 may map, transform, or otherwise convert the set of parameters 365′ defined in the configuration file 345 to a set of configurations to include in the instruction 370 to create the computing cluster 350 and the individual nodes 360 therein. In connection with creation of the computing cluster 350, the cluster manager 330 may configure the node 360 corresponding to the control plane (or primary or principal node). The node 360 corresponding to the control plane may in turn configure the infrastructure and resources for at least a portion of the remainder of the nodes 360 in the computing cluster 350.

In some embodiments, the cluster manager 330 may provide the user interface 335 to control or manage creation or updating the of computing cluster 350. In some embodiments, the cluster manager 330 may provide the user interface 335 to select the configuration file 345 for use in updating or creating other computing clusters. The provision may be in response to the generation of the configuration file 345. For instance, the system administrator may use the user interface 335 to input an identification of the configuration file 345 (e.g., file name and path). Via the user interface 335, the cluster manager 330 may obtain, accept, or otherwise receive an indication to use the configuration file 330 for use in updating or creating other computing clusters. The indication may identify the other computing clusters (e.g., using cluster identifiers). With the receipt of the indication, the cluster manager 330 may update or create one or more other computing clusters in accordance with the configuration file 345.

In this manner, the cluster management system may create and configure updates to the computing cluster, using automatically generated configuration files with minimal input from the system administrator. Once the cluster specification file is identified, the cluster management system may automatically carry out the creation of additional cluster specification files and carry out the updating or creation of the computing cluster. In comparison with manual intervention approaches that entail days or weeks' worth of time and effort, the cluster management system may perform the creation and updating process from start to finish on the order of minutes. The cluster management system may also apply upgrades in a consistent and systematic manner across multiple environments and regions. The cluster management system may thus increase efficiency in creation and upgrading and maintenance of the computing clusters and improve the operational health and security of the computing clusters.

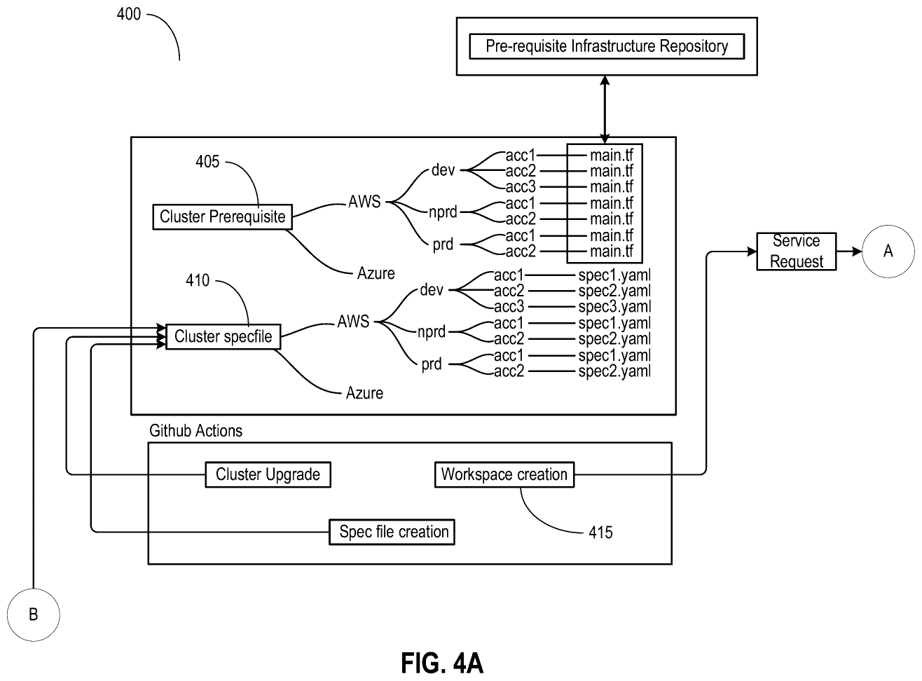

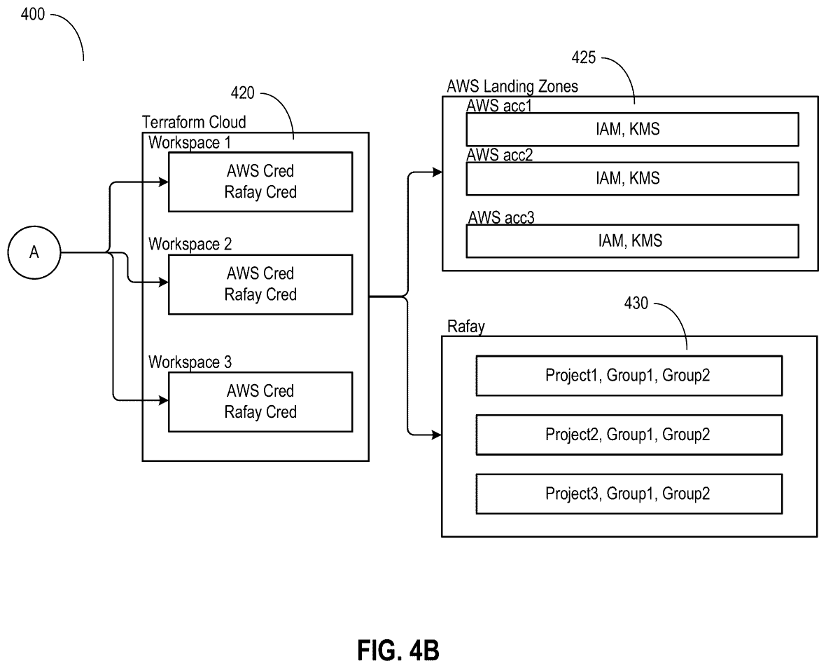

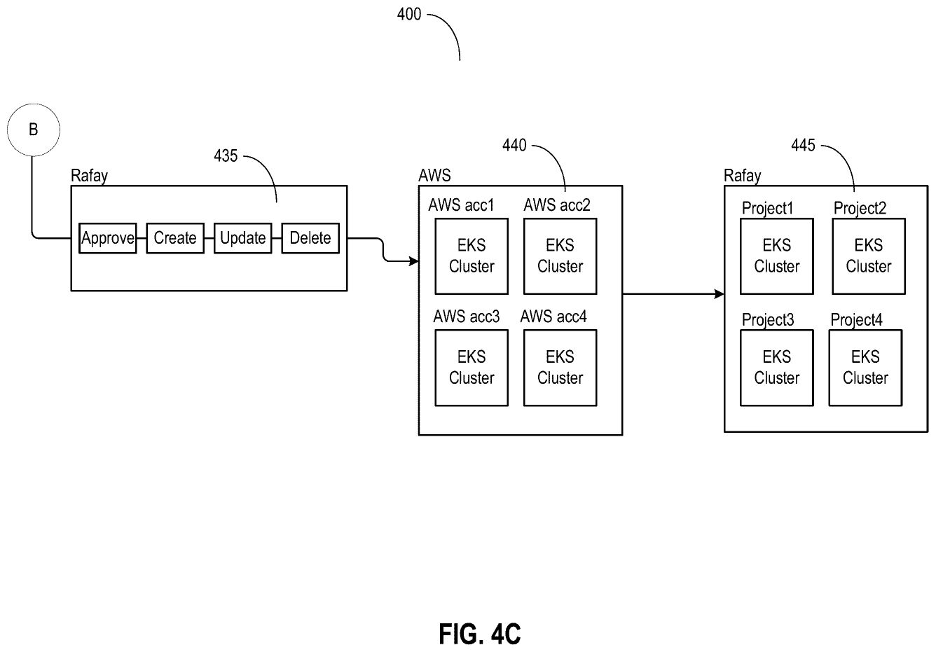

FIGS. 4A-C illustrate a block diagram of a process 400 of automatically generating files to define resources for computing clusters. The process 400 may be performed by a service (e.g., a cloud management service) executing machine-readable software code, though it should be appreciated that the various operations may be performed by one or more computing devices and/or processors. Under the process 400, at step 405, a cluster management service may maintain a set of terraform files (e.g., “main.tf”) for AWS™ and Azure™ computing clusters in different folders. At step 410, the cluster management service may maintain a set of cluster specification files (e.g., in YAML format) on a code base. At step 415, the service may receive a service request to create a workspace. At step 420, the cluster management service may create a workspace to execute the terraform files. In executing, the cluster management service may interface with a pre-requisite infrastructure repository.

At step 425, from executing the terraform files, the cluster management service may create a set of identity and access management (IAM) role identifications and a set of key management service (KMS) keys, among others, for AWS landing zones. At step 430, the cluster management service may generate definitions for projects and groups for Rafay systems (or related resources for groups association) based on executing the terraform files in communication with a resource orchestrator (e.g., Kubernetes orchestration platform). At step 435, the cluster management service uses the cluster specification file may provide the system administrator with option to approve, create, update, or delete clusters. At step 440, with approval, the cluster management service may create one or more clusters (e.g., Elastic Kubernetes Clusters). At step 445, the users can interact with the clusters using the definitions of projects under Rafay systems.

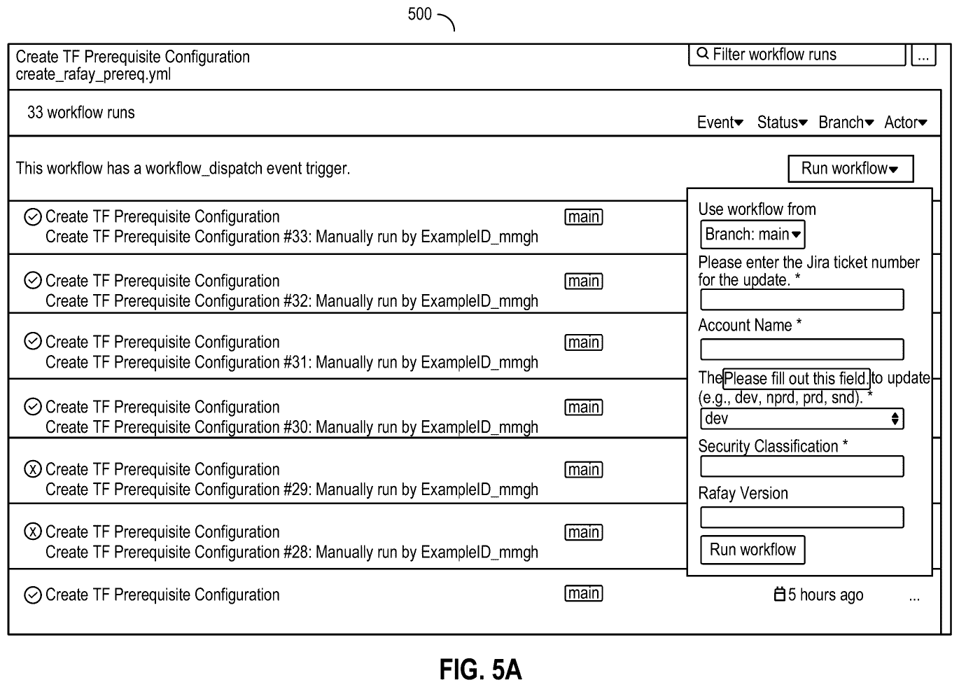

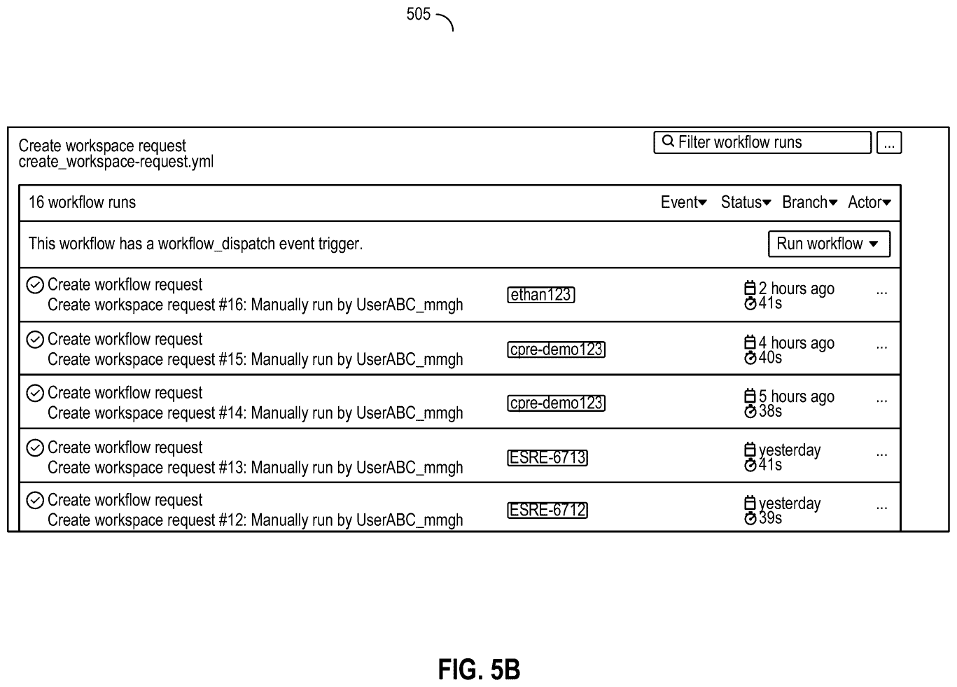

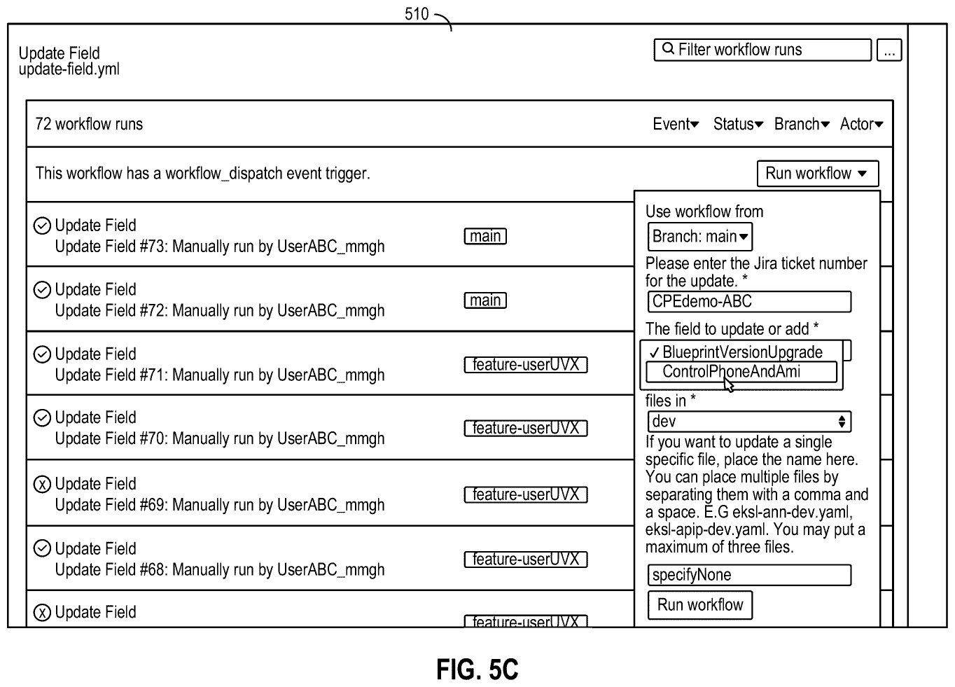

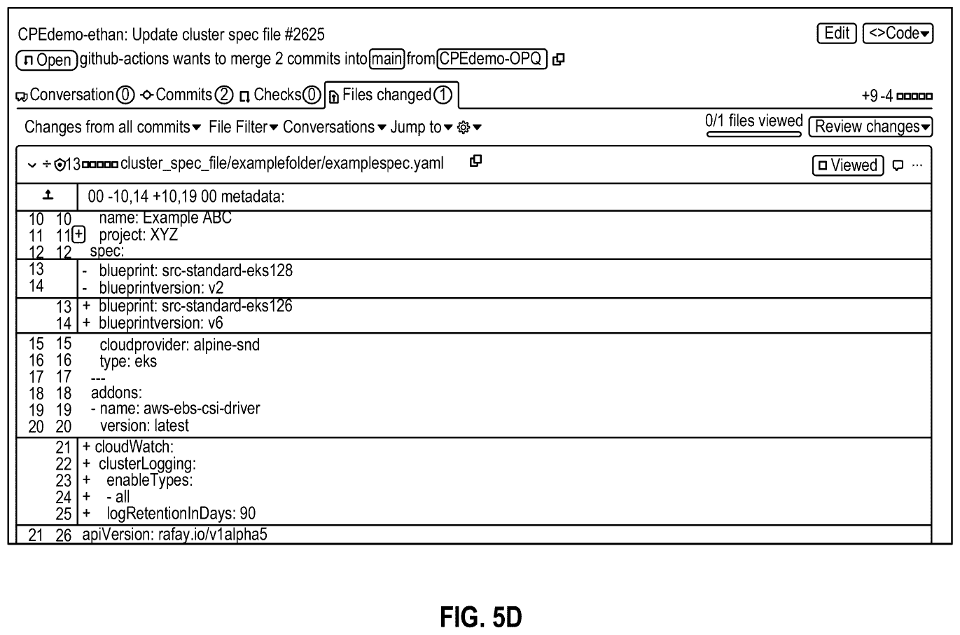

FIG. 5A illustrates a screenshot of a user interface 500 to generate terraform files and code bases. In the depicted example, the user interface 500 may include a user interface element (e.g., a window generally on the right) to enter identification of the main branch. The user interface 500 may generate-a list of terraform configuration files (or pre-requisite configuration files (e.g., spanning generally along the middle). FIG. 5B illustrates a screenshot of a user interface 505 to create the workspace which will be used to execute the terraform files once merged to the main branch. The user interface 505 may include a list of statuses workspace requests that was submitted which will be used to execute the terraform files.

FIG. 5C illustrates a screenshot of a user interface 510 to indicate status of updating of cluster specification files. The user interface 510 may include a list of statuses of updating of cluster specification files (e.g., spanning generally along the middle). The user interface 510 may also include a user interface element (e.g., a window generally on the right) to apply the update in accordance with a selected cluster specification. FIG. 5D illustrates a screenshot of a user interface 515 to indicate status of updating of computing clusters using cluster specification files. The user interface 515 may include a status of updating of a computing cluster and may include a listing of parameters for defining the infrastructure and resources of the computing cluster.

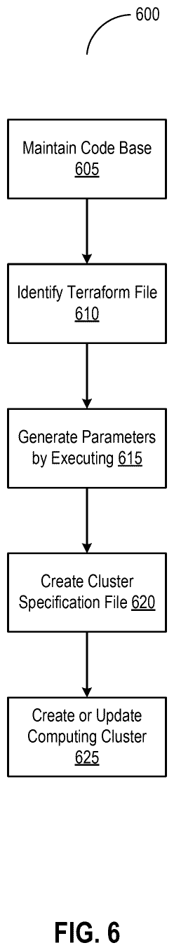

FIG. 6 illustrates a flow diagram of a method 600 of automatically generating files for defining computing clusters. The method 600 may be performed by a service (e.g., a cloud management service) executing machine-readable software code, though it should be appreciated that the various operations may be performed by one or more computing devices and/or processors. At step 605, a service may store and maintain a code base including a set of files for defining infrastructure and resources of a computing cluster. The computing cluster may include a set of nodes on a cloud network supported by a cloud service provider to provide applications and services. The code base may store a history of commits of the code, modifications, and versions of code and branches, among others. The set of files may correspond to a main branch for the infrastructure and resources of the computing cluster.

At step 610, the service may retrieve, receive, or otherwise identify a terraform file. The terraform file may identify a portion of parameters to define resources and infrastructure for the computing cluster. The service may provide a user interface for defining the parameters to include in the terraform file. Upon entry, the service may create the terraform file to include the parameters. The parameters may include, for example, definitions for the application team related tags and group details, among others. In some embodiments, the set of parameters of the terraform file may include an account identifier, a workspace identifier, or a version identifier, among others.

At step 615, the service may create, produce, or otherwise generate a set of parameters by executing the terraform file and the set of files from the code base. The service may execute terraform file and one or more of the set of files in a workspace upon merging the terraform files with the one or more of the set of files with main branch. From execution, the service may generate the set of parameters to further define aspects of the resources and infrastructure for the computing cluster. At step 620, the service may produce, generate, create a cluster specification file, in accordance with the set of parameters. The cluster specification file may be generated include the set of parameters to define the resource and infrastructure of the computing cluster.

At step 625, the service may update or create the computing cluster in accordance with the cluster specification file. The service may update the Kubernetes version and nodes in the computing cluster through a principal node or a control plane that manages resources and infrastructure of the nodes belonging to the computing cluster. In some embodiments, the service may create the computing cluster to include the infrastructure and resources as defined by the cluster specification file. The service may apply the cluster specification file any number of times to create addition computing clusters with the consistent infrastructure and resources.

The foregoing method descriptions and the process flow diagrams are provided merely as illustrative examples and are not intended to require or imply that the steps of the various embodiments must be performed in the order presented. The steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, function, procedure, subroutine, subprogram, or the like. When a process corresponds to a function, the process termination may correspond to a return of the function to a calling function or a main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code, it being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that is accessible by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. “Disk” and “disc”, as used herein, include compact disc (CD), laser disc, optical disc, digital versatile disc (DVD), floppy disk, and Blu-ray disc formats, wherein “disks” reproduce data magnetically, while “discs” reproduce data optically with lasers. Combinations of the above should also be included within the scope of computer-readable media. Additionally, the operations of a method or algorithm may reside as one or any combination or set of codes and/or instructions on a non-transitory, processor-readable medium and/or computer-readable medium, which may be incorporated into a computer program.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A method of automatically generating files for defining computing clusters, comprising:
maintaining, by one or more processors, a code base including a plurality of files to define an infrastructure of a computing cluster including a plurality of nodes;
identifying, by the one or more processors, a first file including a first plurality of parameters for configuring the computing cluster;
generating, by the one or more processors, using the first file with at least one of the plurality of files of the code base, a second plurality of parameters to define a corresponding plurality of resources for the creation of the computing cluster;
creating, by the one or more processors, a second file to define the infrastructure of the computing cluster, using the second plurality of parameters in accordance with a template; and
establishing, by the one or more processors, the infrastructure of the computing cluster in accordance with the second file.

2. The method of claim 1, further comprising providing, by the one or more processors, a user interface comprising a user interface element to input one or more of the first plurality of parameters for configuring the computing cluster, and
wherein identifying the first file further comprises receiving, via the user interface, the first file generated using the first plurality of parameters inputted via the user interface.

3. The method of claim 1, further comprising receiving, by the one or more processors, via the user interface, a selection of one of acceptance or rejection of the second plurality of parameters,
wherein creating the second file further comprises creating, responsive to the selection of the acceptance of the second plurality of parameters, the second file in accordance with the template, the template identifying a plurality of fields and a corresponding plurality of values for the plurality of resources for the creation of the computing cluster.

4. The method of claim 1, further comprising accessing, by the one or more processors, a cloud service provider and resource orchestrator supporting the computing cluster, to retrieve a third plurality of parameters defining a second corresponding plurality of resources for the infrastructure of the computing cluster, the third plurality of parameters identified by the template,
wherein creating the second file further comprises creating the second file using the third plurality of parameters from the cloud service provider and resource orchestrator.

5. The method of claim 1, further comprising receiving, by the one or more processors, via the user interface, a selection of one of acceptance or rejection of the second file,
wherein updating the infrastructure of the computing cluster further comprises creating the infrastructure of the computing cluster in accordance with the second file, responsive to the selection of the acceptance.

6. The method of claim 1, further comprising executing, by the one or more processors, in a workspace associated with the code base, the first file combined with at least one of the plurality of files,
wherein generating the second plurality of parameters further comprises generating the second plurality of parameters based on execution of the first file combined with at least one of the plurality of files in the workspace.

7. The method of claim 1, further comprising receiving, by the one or more processors, via the user interface, an indication to use the second file for updating a plurality of computing clusters,
wherein updating the computing cluster further comprises updating each of the plurality of computing clusters in accordance with the second file.

8. The method of claim 1, wherein updating the computing cluster further comprises updating a control plane of the computing cluster using the second file, the control plane configured to manage resources and a configuration of the computing cluster.

9. The method of claim 1, wherein the first file comprises a terraform file to define the creation of the infrastructure of the computing cluster, and the first plurality of parameters comprises at least one of: (i) an account identifier, (ii) a workspace identifier, or (iii) a version identifier, and
wherein the second file comprises a cluster specification file to define resources of the computing cluster, and wherein the second plurality of parameters comprises at least one of: (i) an identity and access management (IAM) role identification, (ii) a key management service (KMS) key, or (iii) an access management for users.

10. The method of claim 1, wherein the computing cluster comprises at least one primary node managing the plurality of nodes, at least one of the plurality of nodes associated with a container to provide a service.

11. A system for automatically generating files for defining computing clusters, comprising:
one or more processors coupled with memory, configured to:
maintain a code base including a plurality of files to define an infrastructure of a computing cluster including a plurality of nodes;
identify a first file including a first plurality of parameters for configuring the computing cluster;
generate, using the first file with at least one of the plurality of files of the code base, a second plurality of parameters to define a corresponding plurality of resources for creation of the computing cluster;
create a second file to define the infrastructure of the computing cluster, using the second plurality of parameters in accordance with a template; and
establish the infrastructure of the computing cluster in accordance with the second file.

12. The system of claim 11, wherein the one or more processors are configured to:
provide a user interface comprising a user interface element to input one or more of the first plurality of parameters for configuring the computing cluster, and
receive, via the user interface, the first file generated using the first plurality of parameters inputted via the user interface.

13. The system of claim 11, wherein the one or more processors are configured to:
receive, via the user interface, a selection of one of acceptance or rejection of the second plurality of parameters, and
create, responsive to the selection of the acceptance of the second plurality of parameters, the second file in accordance with the template, the template identifying a plurality of fields and a corresponding plurality of values for the plurality of resources for configuring the computing cluster.

14. The system of claim 11, wherein the one or more processors are configured to:
access a cloud service provider and a resource orchestrator supporting the computing cluster, to retrieve a third plurality of parameters defining a second corresponding plurality of resources for the infrastructure of the computing cluster, the third plurality of parameters identified by the template, and
create the second file using the third plurality of parameters from the cloud service provider and resource orchestrator.

15. The system of claim 11, wherein the one or more processors are configured to:
receive, via the user interface, a selection of one of acceptance or rejection of the second file, and
create the infrastructure of the computing cluster in accordance with the second file, responsive to the selection of the acceptance.

16. The system of claim 11, wherein the one or more processors are configured to:
execute, in a workspace associated with the code base, the first file combined with at least one of the plurality of files; and
generate the second plurality of parameters based on execution of the first file combined with at least one of the plurality of files in the workspace.

17. The system of claim 11, wherein the one or more processors are configured to:
receive, via the user interface, an indication to use the second file for updating a plurality of computing clusters,
update each of the plurality of computing clusters in accordance with the second file.

18. The system of claim 11, wherein the one or more processors are configured to update a control plane of the computing cluster using the second file, the control plane configured to manage resources and a configuration of the computing cluster.

19. The system of claim 11, wherein the first file comprises a terraform file for configuring of the infrastructure of the computing cluster, and the first plurality of parameters comprises at least one of: (i) an account identifier, (ii) a workspace identifier, or (iii) a version identifier, and
wherein the second file comprises a cluster specification file to define resources of the computing cluster, and wherein the second plurality of parameters comprises at least one of: (i) an identity and access management (IAM) role identification, (ii) a key management service (KMS) key, or (iii) an access management for users.

20. The system of claim 11, wherein the computing cluster comprises at least one primary node managing the plurality of nodes, at least one of the plurality of nodes associated with a container to provide a service.
